(19) United States
(12) Patent Application Publication
(10) Pub. No.: US 2017/0267280 A1
(43) Pub. Date: Sep. 21, 2017

(54) SYSTEMS AND METHODS FOR FEASIBLE STATE DETERMINATION IN DRIVER COMMAND INTERPRETER

(71) Applicant: GM GLOBAL TECHNOLOGY OPERATIONS LLC, Detroit, MI (US)

(72) Inventors: SEYED ALIREZA KASAIEZADEH MAHABADI, SHELBY TOWNSHIP, MI (US); SHIH-KEN CHEN, TROY, MI (US); AMIR KHAJEPOUR, WATERLOO (CA); BAKHTIAR B. LITKOUHI, WASHINGTON, MI (US)

(73) Assignee: GM GLOBAL TECHNOLOGY OPERATIONS LLC, Detroit, MI (US)

(21) Appl. No.: 15/070,948

(22) Filed: Mar. 15, 2016

(51) Int. Cl. B62D 6/00; G05D 1/02; G05D 1/08

(52) U.S. Cl. CPC B62D 6/003; G05D 1/0891; G05D 1/0223; G05D 1/0214

(57) ABSTRACT

Methods and systems are provided for controlling a component of a vehicle. In one embodiment, a method includes: receiving sensor data sensed from the vehicle; processing the sensor data to determine an ideal state of the vehicle; processing the sensor data and the ideal state of the vehicle to determine a feasible state of the vehicle; and selectively controlling at least one component associated with at least one of an active safety system and a chassis system of the vehicle based on the at least one feasible state.

### TECHNICAL FIELD

The technical field generally relates to control systems of a vehicle, and more particularly to methods and systems for controlling a vehicle based on a feasible state determination.

### BACKGROUND

Active safety systems or chassis control systems are designed to improve a motor vehicle's handling, for example at the limits where the driver might lose control of the motor vehicle. The systems compare the driver's intentions, for example, by direction in steering, throttle, and/or braking inputs, to the motor vehicle's response, via lateral acceleration, rotation (yaw) and individual wheel speeds. The systems then control the vehicle, for example, by braking individual front or rear wheels, by steering the wheels, and/or by reducing excess engine power as needed to help correct understeer (plowing) or oversteer (fishtailing).

These systems use several sensors in order to determine the intent of the driver and to determine a driver intended state. Other sensors indicate the actual state of the motor vehicle (motor vehicle response). The systems compare driver intended state with the actual state and decide, when necessary, to adjust the actuators of the motor vehicle.

In order to determine the driver intended state, the systems include a driver command interpreter. The driver command interpreter generates an ideal state and corrects the ideal state for different driving and road conditions. In order to determine the ideal state, the driver command interpreter needs the exact value of the road friction coefficient that is not practically available. Ideal states are technically defined based on vehicle behavior on dry road. A set of patches are used to compensate for any uncertainty in road condition detection. Tuning of these patches is very time consuming and costly.

Accordingly, it is desirable to provide improved methods and systems for determining a driver intended state and controlling the vehicle based thereon. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for controlling a component of a vehicle. In one embodiment, a method includes: receiving sensor data sensed from the vehicle; processing the sensor data to determine an ideal state of the vehicle; processing the sensor data and the ideal state of the vehicle to determine a feasible state of the vehicle; and selectively controlling at least one component associated with an active safety system or a chassis system of the vehicle based on the at least one feasible state.

In one embodiment, a system includes a non-transitory computer readable medium. The non-transitory computer readable medium includes a first module that receives sensor data sensed from the vehicle, and that processes the sensor data to determine an ideal state of the vehicle. The non-transitory computer readable medium further includes a second module that processes the sensor data and the ideal state of the vehicle to determine a feasible state of the vehicle. The non-transitory computer readable medium further includes a third module that selectively controls at least one component associated with an active safety system or a chassis system of the vehicle based on the at least one feasible state.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a controls system having feasible motion determination system in accordance with various embodiments;

FIG. 2 is a dataflow diagram illustrating the control system in accordance with various embodiments; and

FIG. 3 is a flowchart illustrating a control method in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of control systems, and that the vehicle system described herein is merely one example embodiment.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in various embodiments.

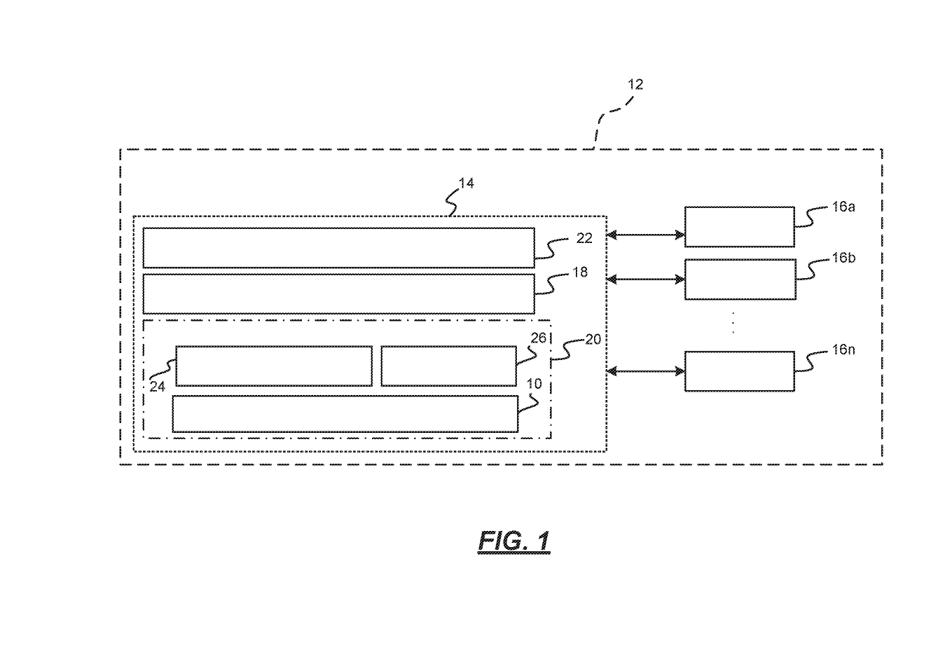

With reference now to FIG. 1, a vehicle 12 is shown to include a feasible state determination system 10 in accordance with various embodiments. Although the figures shown herein depict an example with certain arrangements of elements, additional intervening elements, devices, features, or components may be present in actual embodiments. It should also be understood that FIG. 1 is merely illustrative and may not be drawn to scale.

As shown, the vehicle 12 includes a control module 14. The control module 14 controls one or more components 16a-16n of the vehicle 12. The components 16a-16n may be associated with a chassis system or active safety system of the vehicle 12. For example, the control module 14 controls vehicle components 16a-16n of a braking system (not shown), a steering system (not shown), and/or a chassis system (not shown) of the vehicle 12.

In various embodiments, the control module 14 includes at least one processor 18, memory 20, and one or more input and/or output (I/O) devices 22. The I/O devices 22 communicate with one or more sensors and/or actuators associated with the components 16a-16n of the vehicle 12. The memory 20 stores instructions that can be performed by the processor 18. The instructions stored in memory 20 may include one or more separate programs, each of which comprises an ordered listing of executable instructions for implementing logical functions.

In the example of FIG. 1, the instructions stored in the memory 20 are part of a main operating system (MOS) 24. The main operating system 24 includes logic for controlling the performance of the control module 14 and provides scheduling, input-output control, file and data management, memory management, and communication control and related services. In various embodiments, the instructions are further part of the feasible state determination system 10 and one or more component control systems 26 described herein.

When the control module 14 is in operation, the processor 18 is configured to execute the instructions stored within the memory 20, to communicate data to and from the memory 20, and to generally control operations of the vehicle 12 pursuant to the instructions. The processor 18 can be any custom made or commercially available processor, a central processing unit (CPU), an auxiliary processor among several processors associated with the control module 14, a semiconductor based microprocessor (in the form of a microchip or chip set), a macroprocessor, or generally any device for executing instructions.

In various embodiments, the processor 18 executes the instructions of the feasible state determination system 10 and one or more of the component control systems 26. The feasible state determination system 10 generally determines one or more feasible states of motion of the vehicle 12 given the driver's intent (also referred to as the feasible driver intended state). The feasible state is the most achievable state given a certain road condition while the steer-ability and stability of vehicle 12 can be maintained. The feasible state determination system 10 then provides the feasible state to the component control systems 26 to generate control signals to control the vehicle components 16a-16n. Since the feasible states are achievable even on certain road conditions (e.g., slippery road conditions, or other road conditions), control performance is improved and control tuning becomes much easier.

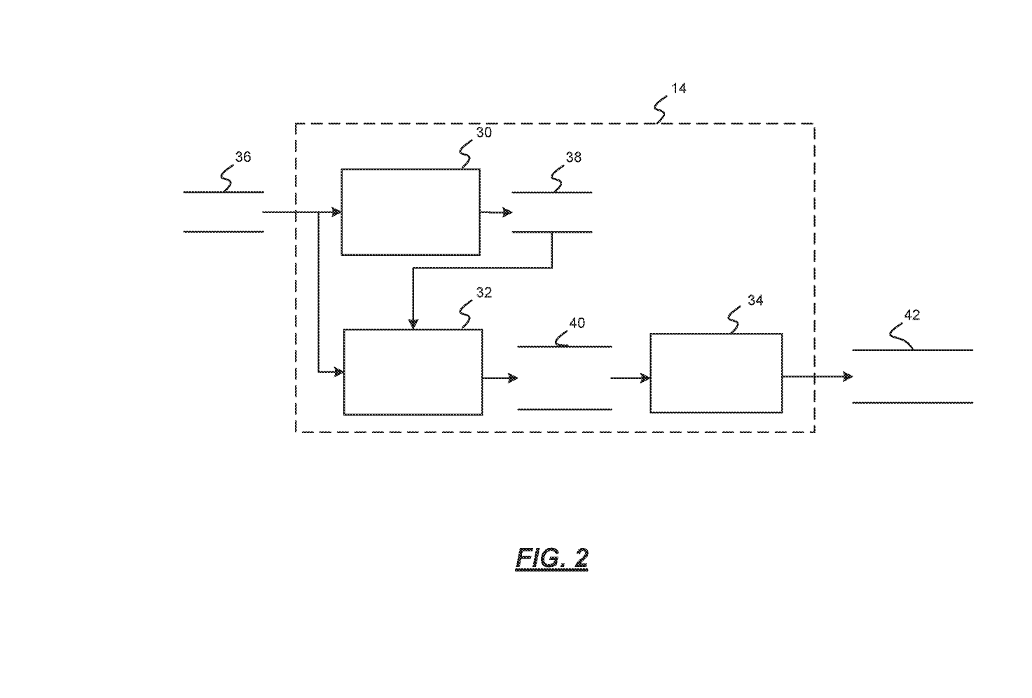

Referring now to FIG. 2 and with continued reference to FIG. 1, a dataflow diagram illustrates the feasible state determination system 10 in more detail in accordance with various exemplary embodiments. As can be appreciated, various exemplary embodiments of the feasible state determination system 10, according to the present disclosure, may include any number of modules and/or sub-modules. In various exemplary embodiments, the modules and sub-modules shown in FIG. 2 may be combined and/or further partitioned to similarly determine a feasible state of motion of the vehicle 12 and to control the vehicle 12 based thereon. In various embodiments, the feasible state determination system 10 receives inputs from the one or more sensors associated with the components 16a-16n of the vehicle 12, from other control modules (not shown) within the vehicle 12, and/or from other modules (not shown) within the control module 14. In various embodiments, the feasible state determination system 10 includes an ideal motion computation module 30, an intermediate control module 32, and a translator module 34.

The ideal motion computation module 30 receives as input sensor data 36 from the sensors associated with the components 16a-16n, such as, but not limited to, steering angle data, wheel speed data, inertial measurement unit sensor data, gas pedal position data, and/or brake pedal position data. The ideal motion computation module 30 computes the ideal motion based on the inputs. In various embodiments, the ideal motion includes an ideal yaw rate and ideal lateral velocity. The ideal yaw rate can be computed, for example, based on the following equation:

$${r}_{des} = \frac{u ( δ )}{2 ( L + {K}_{us} {u}^{2} )} . \qquad ( 1 )$$

The ideal lateral velocity can be computed, for example, based on the following equation:

$${v}_{ydes} = {r}_{des} ( b - \frac{a m}{L {C}_{r , dry}} {u}^{2} ) . \qquad ( 2 )$$

In the equations above, Kᵤₛ represents under steer coefficient, δ represents steering angle on a road, a, b represent the distance between front and rear axles to CG respectively, m, L and u represent mass, wheel base and the velocity of vehicle 12 respectively, and Cᵣ represents the rear lateral tire stiffness on a dry road.

The intermediate control module 32 receives as input the sensor data 36 associated with the components 16a-16n, such as, but not limited to, steering angle data, wheel speed data, inertial measurement unit sensor data, gas pedal position data, and/or brake pedal position data. The intermediate control module 32 computes the intermediate control action. For example, the computation for controlling vehicle yaw and side-slip is as follows. As can be appreciated, the intermediate controller can be for any chassis control or active safety system control parameter and is not limited to present examples.

Initially, model selection is performed. In various embodiments, a two degree of freedom bicycle model is selected as:

$$\begin{matrix}[ \begin{matrix}{\dot{v}}_{y} \\ \dot{r}\end{matrix} ] = [ \begin{matrix}\frac{- 2 ( {C}_{{α}_{r}} + {C}_{{α}_{f}} cos δ )}{m u} & \frac{2 ( b {C}_{{α}_{r}} - a {C}_{{α}_{f}} )}{m u} - u \\ \frac{2 ( b {C}_{{α}_{r}} - a {C}_{{α}_{f}} cos δ )}{{I}_{z} u} & \frac{- 2 ( {a}^{2} {C}_{{α}_{f}} cos δ + {b}^{2} {C}_{{α}_{r}} )}{{I}_{z} u}\end{matrix} ] \begin{matrix}{v}_{y} \\ r\end{matrix} + [ \begin{matrix}0 \\ \frac{1}{{I}_{z}}\end{matrix} ] {M}_{z} + [ \begin{matrix}\frac{\begin{matrix}( {F}_{{y}_{{f}_{0}}} - 2 {C}_{{α}_{f}} {α}_{{f}_{0}} ) cos δ + ( {F}_{{y}_{{r}_{0}}} - 2 {C}_{{α}_{r}} {α}_{{r}_{0}} ) + \\ {F}_{{x}_{f}} sin δ + 2 {C}_{{α}_{f}} δ cos δ\end{matrix}}{m} \\ \frac{\begin{matrix}a ( {F}_{{y}_{{f}_{0}}} - 2 {C}_{{α}_{f}} {α}_{{f}_{0}} ) cos δ - \\ b ( {F}_{{y}_{{r}_{0}}} - 2 {C}_{{α}_{r}} {α}_{{r}_{0}} ) + 2 {bC}_{{α}_{f}} δ cos δ\end{matrix}}{{I}_{z}}\end{matrix} ] ; & ( 3 ) \\ and & \\ \dot{x} = Ax ( t ) + Bu ( t ) + {W}_{0} . & ( 4 )\end{matrix}$$

Thereafter, the model predictive control target function definition is established as:

J=e_{N}_{ₚ}^{T}Pe_{N}_{ₚ}+Σₖ₌₀^{N}^{ₚ}⁻¹eₖ^{T}Qeₖ+M_{z}_{ₖ}^{T}RM_{z}_{ₖ}; and (5)

e=X−X_{d}. (6)

X and X_{d} represent vehicle actual and desired states (ideal states 38 from initial equations) respectively.

Thereafter, the model predictive control is established as:

$$\begin{matrix}\begin{matrix} χ = {\{ x ( 0 ) \vert x ( 1 ) \vert … \vert x ( N - 1 ) \}}^{T} \\ = {S}^{x} x ( 0 ) + {S}^{u} {U}_{0} + {S}^{w} {W}_{0} ;\end{matrix} & ( 7 ) \\ {S}^{x} = [ \begin{matrix}I \\ A \\ {A}^{2} \\ ⋮ \\ {A}^{N}\end{matrix} ] , {S}^{u} = [ \begin{matrix}0 & … & … & 0 \\ B & 0 & … & 0 \\ AB & ⋱ & ⋱ & ⋮ \\ ⋮ & ⋱ & ⋱ & ⋮ \\ {A}^{N - 1} B & … & … & B\end{matrix} ] , {S}^{w} = [ \begin{matrix}0 \\ I \\ A + I \\ ⋮ \\ {A}^{N - 1} + … + A + I\end{matrix} ] ; & ( 8 ) \\ ε = χ - {χ}_{d} ; & ( 9 ) \\ J = {ε}^{T} \overline{Q} ε + {U}_{0}^{T} \overline{R} {U}_{0} ; and & ( 10 ) \\ J = {U}_{0}^{T} ( {\underbrace{{S}^{{u}^{T}} \overline{Q} {S}^{u} + \overline{R}}}_{H} ) {\underbrace{{S}^{{u}^{T}} \overline{Q} {S}^{u} + \overline{R}}}_{H} {U}_{0} + ( \underbrace{2 {x}_{0}^{T} {S}^{{x}^{T}} \overline{Q} {S}^{u} + 2 {W}^{T} {S}^{{w}^{T}} \overline{Q} {S}^{u} - 2 {χ}_{d}^{T} \overline{Q} {S}^{u}}_{g} ) {U}_{0} + C . & \end{matrix}$$

The final solution for the model predictive control is then provided as:

U₀*=−H⁻¹g, subject to constraint on U₀*. (12)

The translator module 34 receives as input the controller design output 40, which in the example above is the yaw moment adjustment. The translator module 34 computes the feasible state(s) 42 from the controller design output 40. For example, provided the vehicle in the following form:

\dot{x}=Ax(t)+BU(t)+W. (13)

Then the feasible state 42 can be translated from the intermediate control action as:

\dot{x}=Ax(t)+BU₀*(t)+W. (14)

U₀*(t)=U_{IC}(t) represents the intermediate control action. The feasible state x is then provided to the one or more component control systems 26 for generating the control signals.

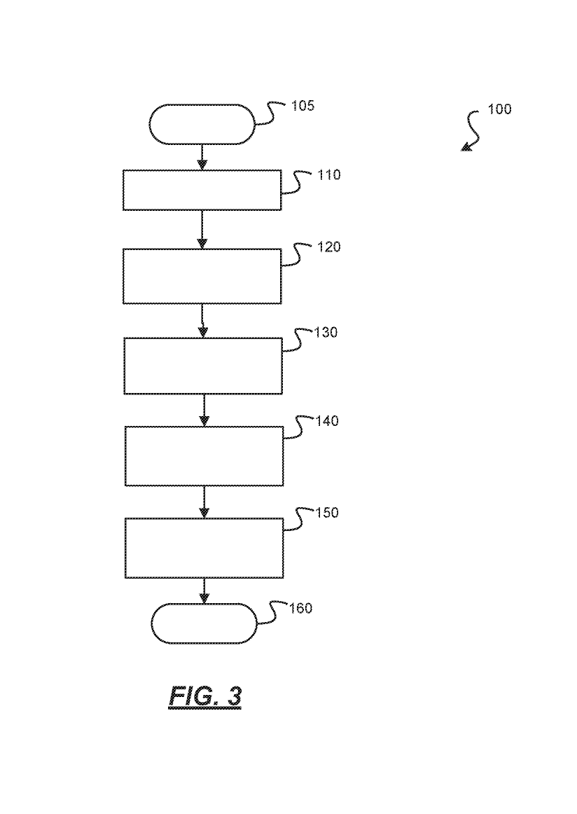

With reference now to FIG. 3, and with continued reference to FIGS. 1 and 2, a flowchart illustrates a method 100 for determining the feasible state(s) 42 and controlling one or more components 16a-16n of the vehicle 12 based thereon. The method 100 can be implemented in connection with the vehicle 12 of FIG. 1 and can be performed by the feasible state determination system 10 of FIG. 2, in accordance with various exemplary embodiments. As can be appreciated in light of the disclosure, the order of operation within the method 100 is not limited to the sequential execution as illustrated in FIG. 3, but may be performed in one or more varying orders as applicable and in accordance with the present disclosure. As can further be appreciated, the method 100 of FIG. 3 may be enabled to run continuously, may be scheduled to run at predetermined time intervals during operation of the vehicle 12 and/or may be scheduled to run based on predetermined events.

In various embodiments, the method may begin at 105. The sensor data 36 is received at 110. The ideal states are estimated, for example, as discussed above at 120. The intermediate controller that satisfies the control performance requirements is established, for example, as discussed above at 130 and the yaw moment adjustment is computed. The output of the intermediate controller is then translated to the feasible states using vehicle dynamics model, for example, as discussed above at 140. The feasible states are then provided to the component control systems 26 at 150 to control the component based thereon. Thereafter, the method may end at 160.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling a component of a vehicle, comprising:
receiving sensor data sensed from the vehicle;
processing the sensor data to determine an ideal state of the vehicle;
processing the sensor data and the ideal state of the vehicle to determine a feasible state of the vehicle; and
selectively controlling at least one component associated with at least one of an active safety system and a chassis system of the vehicle based on the at least one feasible state.

2. The method of claim 1, further comprising determining an intermediate controller based on the sensor data, and wherein the processing the sensor data to determine a feasible state of the vehicle is based on the intermediate controller.

3. The method of claim 1, wherein the intermediate controller is a model predictive control.

4. The method of claim 2, further comprising translating an output of the intermediate controller to determine the at least one feasible state.

5. The method of claim 1, wherein the sensor data includes steering angle data, wheel speed data, inertial measurement unit sensor data, gas pedal position data, and brake pedal position data.

6. The method of claim 1, wherein the feasible state is associated with yaw rate of the vehicle.

7. The method of claim 1, wherein the feasible state is associated with side slip angle of the vehicle.

8. The method of claim 1, wherein the feasible state is a most achievable state given a certain road condition while the steer-ability and stability of vehicle can be maintained.

9. A system for controlling a component of a vehicle, comprising:
a non-transitory computer readable medium comprising:
a first module that receives sensor data sensed from the vehicle, and that processes the sensor data to determine an ideal state of the vehicle;
a second module that processes the sensor data and the ideal state of the vehicle to determine a feasible state of the vehicle; and
a third module that selectively controls at least one component associated with at least one of an active safety system and a chassis system of the vehicle based on the at least one feasible state.

10. The system of claim 9, further comprising a fourth module that determines an intermediate controller based on the sensor data, and wherein the third module processes the sensor data to determine a feasible state of the vehicle based on the intermediate controller.

11. The method of claim 9, wherein the intermediate controller is a model predictive control.

12. The system of claim 11, wherein the second module translates an output of the intermediate controller to determine the at least one feasible state.

13. The system of claim 9, wherein the sensor data includes steering angle data, wheel speed data, inertial measurement unit sensor data, gas pedal position data, and brake pedal position data.

14. The system of claim 9, wherein the feasible state is associated with yaw rate of the vehicle.

15. The system of claim 9, wherein the feasible state is associated with side slip angle of the vehicle.

16. The system of claim 9, wherein the feasible state is a most achievable state given a certain road condition while the steer-ability and stability of vehicle can be maintained.

17. A vehicle, comprising:
at least one component associated with at least one of an active safety system and a chassis system; and
a control module comprising:
a first module that receives sensor data sensed from the vehicle, and that processes the sensor data to determine an ideal state of the vehicle;
a second module that processes the sensor data and the ideal state of the vehicle to determine a feasible state of the vehicle; and
a third module that selectively controls at least one component associated with at least one of an active safety system and a chassis system of the vehicle based on the at least one feasible state.
